(19) United States
(12) Patent Application Publication
(10) Pub. No.: US 2017/0276335 A1
(43) Pub. Date: Sep. 28, 2017

(54) ILLUMINATION DEVICE

(71) Applicant: Samsung Electronics Co., Ltd, Gyeonggi-do (KR)

(72) Inventors: Hyeong-won Yun, Gyeonggi-do (KR); Wook-pyo Lee, Seoul (KR); Seok-kyu Kim, Gyeonggi-do (KR); Young-ho Jung, Gyeonggi-do (KR)

(21) Appl. No.: 15/523,347

(22) PCT Filed: Dec. 16, 2015
(86) PCT No.: PCT/KR2015/013822

§ 371 Date: Apr. 28, 2017

(30) Foreign Application Priority Data
Dec. 17, 2014 (KR) 10-2014-0182550

(51) Int. Cl. F21V 21/30; H05B 33/08; F21S 8/00

(52) U.S. Cl. CPC F21V 21/30; F21S 8/035; H05B 33/0896; F21Y 2115/10

(57) ABSTRACT

An illumination device is provided. The illumination device includes a heat sink coupled to a housing, and the heat sink includes at least one heat dissipation pin extending from an external surface of the housing. Vent holes that expose the external surface of the housing, an inside of the housing, or an inside of the illumination device to external air are formed on a side of the at least one heat dissipation pin. An upper edge of the housing and the heat sink may be spaced apart from each other, and the spaced region may include a gap that exposes the illumination device or the inside of the housing.

### TECHNICAL FIELD

The present disclosure relates to illumination devices, and more particularly, to illumination devices having at least a part of an upper edge of a housing thereof exposed.

### BACKGROUND ART

An illumination device is generally used for securing a clear view in a dark place, expressing a visual effect of an advertisement, or having an aesthetic purpose. A light source of an illumination device may include an incandescent light, a fluorescent light, or a halogen light. In recent years, a light-emitting diode (LED) is used as a light source.

An LED used in an illumination device may realize various colors of light by changing a compound semiconductor material, such as GaAs, AlGaAs, GaN, and InGaInP. LEDs have merits of having a long lifetime, being miniature and light, and low voltage driving is possible due to strong directionality of light. An illumination device that employs an LED is widely used in various fields due to its high optical efficiency, high eco-friendliness, and low power consumption and applications thereof are gradually increasing.

Heat generated from a light source or a power supply unit of an illumination device may adversely affect the performance and lifetime of the illumination device. Thus, various methods may be applied to dissipate the heat to the outside. For example, the method includes a forced air cooling system by using a fan or a natural cooling method by using a heat sink.

### DISCLOSURE OF INVENTION

### Solution to Problem

Provided are illumination devices having a structure for effectively dissipating heat generated from a light source or a power supply unit in the illumination devices to the outside.

Provided are illumination devices that have a high heat dissipation efficiency and satisfy the American National Standards Institute (ANSI) Specification.

Additional aspects will be set forth in part in the description which follows and, in part, will be apparent from the description, or may be learned by practice of the presented exemplary embodiments.

According to an aspect of an exemplary embodiment, an illumination device includes: a power supply unit inserted in a housing; a heat sink coupled to the housing; and a light source unit formed on the heat sink, wherein the heat sink comprises at least one heat dissipation pin extending towards an outer surface of the housing and vent holes formed on a side of the heat dissipation pins.

The at least one heat dissipation pin may include first heat dissipation pins and second heat dissipation pins.

The vent holes may be formed between the first heat dissipation pins and the second heat dissipation pins.

The vent holes may expose a surface of the housing to external air outside the illumination device.

The vent holes expose an inside of the illumination device to external air.

The illumination device may further include a gap formed by separating the housing from the heat sink.

The gap may be formed by separating a body unit of the heat sink from an edge of the housing, and the gap exposes an inside of the housing or the illumination device to external air.

The illumination device may further include a cover unit formed on the light source unit, and the cover unit may include at least one lens element.

The light source unit may include at least one light-emitting device, and the at least one lens element may correspond to the at least one light-emitting device and the at least one lens element may overlap with each other.

The illumination device may further include a plate formed on the housing, and the light source unit may be formed on the plate.

According to an aspect of another exemplary embodiment, an illumination device includes: a housing; a power supply unit inserted in the housing; a heat sink coupled to the housing; and a light source unit formed on the heat sink, wherein the heat sink includes: at least one heat dissipation pin extending from an outer surface of the housing; a first vent hole downwardly formed from an upper surface of the heat sink and passing through the heat sink; and second vent holes formed on a side of the heat dissipation pins.

The illumination device may further include inner heat dissipation pins that are formed in the first vent hole and protrude from an inner surface of the heat sink.

The illumination device may further include at least one partition wall protruding from an outer surface of the heat sink.

The at least one partition wall may protrude from a side surface of the heat sink and may extend towards the at least one heat dissipation pin.

The first vent hole and the second vent holes may be connected to each other.

### Advantageous Effects of Invention

According to the current exemplary embodiment, an illumination device having a structure by which heat generated from a light source unit or a PSU may efficiently dissipate to the outside of the illumination device is provided. The weight of a heat sink may be reduced by forming at least one of heat dissipation pins and exposing a housing or an inner space of the housing between the heat dissipation pins. Also, an illumination device that satisfies the lamp specification of the American National Standards Institute (ANSI) and a high speed dimmable illumination device are provided.

### BRIEF DESCRIPTION OF DRAWINGS

These and/or other aspects will become apparent and more readily appreciated from the following description of the exemplary embodiments, taken in conjunction with the accompanying drawings in which:

FIG. 1 is an exploded perspective view of an illumination device according to an exemplary embodiment;

FIG. 2 is a lateral view of an illumination device according to an exemplary embodiment;

FIG. 3 is a schematic lateral cross-sectional view of the illumination device of FIG. 2;

FIG. 4a is a plan view of a cover unit of an illumination device according to an exemplary embodiment;

FIG. 4b is a bottom view of a cover unit of an illumination device according to an exemplary embodiment;

FIG. 4c is a perspective view of a bottom of a cover unit of an illumination device according to an exemplary embodiment;

FIG. 5a is a lateral view of an illumination device having a gap between a housing and a heat sink, according to an exemplary embodiment;

FIG. 5b is a schematic lateral cross-sectional view of the illumination device of FIG. 5a;

FIG. 6 is a lateral cross-sectional view of an illumination device having a plate between a housing and a heat sink;

FIG. 7 is a lateral view of an illumination device having a heat sink formed by a press cutting method;

FIG. 8 is a perspective view of an illumination device according to another exemplary embodiment;

FIG. 9a is a perspective view of the illumination device of FIG. 8 having a structure in which a housing and a heat sink are separate from each other;

FIG. 9b is a plan view of an upper surface of the illumination device of FIG. 8; and

FIG. 10 is a perspective view of a modified version of the illumination device of FIG. 9a.

### MODE FOR THE INVENTION

Reference will now be made in detail to exemplary embodiments, examples of which are illustrated in the accompanying drawings, wherein like reference numerals refer to like elements throughout. In the drawings, the sizes or thicknesses of constituent elements are exaggerated for clarity.

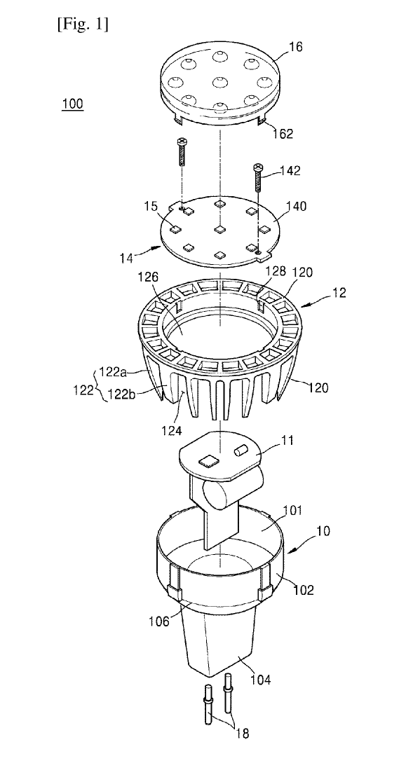

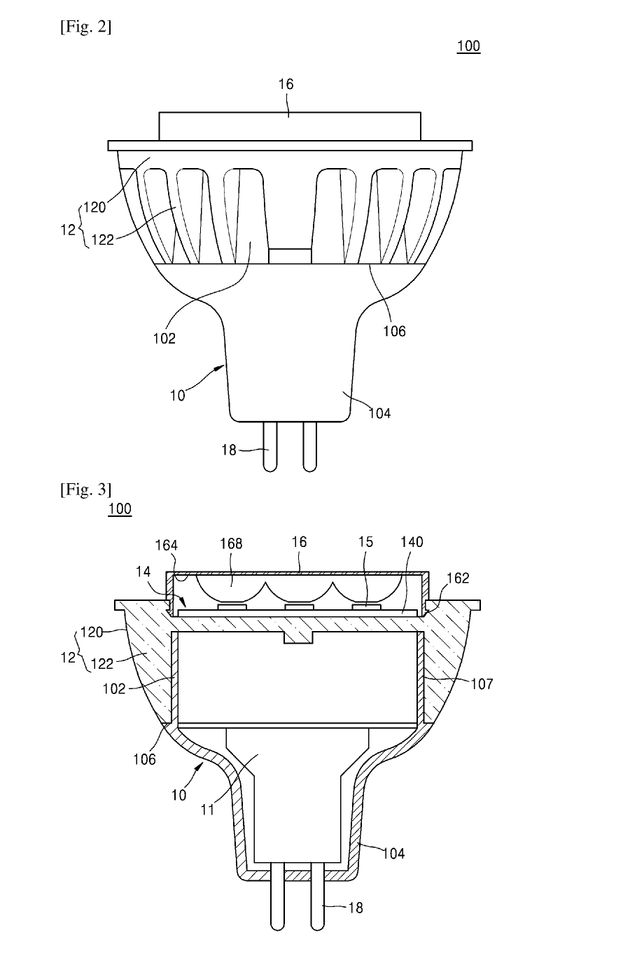

FIG. 1 is an exploded perspective view of an illumination device 100 according to an exemplary embodiment. FIG. 2 is a lateral view of the illumination device 100.

Referring to FIGS. 1 and 2, the illumination device 100 according to an exemplary embodiment may include a housing 10, a power supply unit (PSU) 11 inserted into the housing 10, and a heat sink 12 coupled to the housing 10. Also, the illumination device 100 may include a light source unit 14 that is placed on the heat sink 12 to irradiate light to the outside and a cover unit 16 that covers the light source unit 14. A terminal unit 18 to receive external power may be formed on an edge, for example, a lower side of the housing 10, and the external power received from the terminal unit 18 may be supplied to the light source unit 14 through the PSU 11. The housing 10 may be divided into a lower housing 104 to which the terminal unit 18 is connected and an upper housing 102 that is coupled to the heat sink 12. However, the housing 10 is divided to the lower housing 104 and the upper housing 102 for convenience of explanation. However, the housing 10 may be formed as one whole body.

The heat sink 12 may be formed by including a material, such as, a metal or an alloy having high thermal conductivity to cover the upper housing 102 of the housing 10 and to rapidly dissipate heat generated from the inside of the illumination device 100 to the outside. Also, the heat sink 12 may include at least one of heat dissipation pins 122 to effectively dissipate heat inside the illumination device 100 to the outside. The heat dissipation pins 122 may be formed by extending from a body unit 120 of the heat sink 12 towards an external surface of the housing 10. The heat dissipation pins 122 may tightly contact with the external surface of the housing 10 or some of the heat dissipation pins 122 may be spaced apart from the housing 10. Vent holes 124 may be formed at least on a side of the heat dissipation pins 122. The heat dissipation pins 122 may have various types. The heat dissipation pins 122 may include a first heat dissipation pin 122a and a second heat dissipation pin 122b respectively having different lengths and widths from each other. Also, the heat dissipation pins 122 may include a plurality of the first heat dissipation pins 122a having the same shape and a small number of the second heat dissipation pins 122b having different shapes from the first heat dissipation pins 122a. The shape of the heat dissipation pin 122 is not limited. The heat dissipation pins 122 may form a contact unit 107 by directly contacting the housing 10. However, the current exemplary embodiment is not limited thereto, that is, the heat dissipation pins 122 may be spaced apart from the housing 10.

The heat dissipation pins 122 may be spaced apart from each other. The vent holes 124 may be formed on at least a side of the heat dissipation pins 122 or, as depicted in FIGS. 1 and 2, between the heat dissipation pins 122, for example, between the first and second heat dissipation pins 122a and 122b. An external surface and the inside of the housing 10 or the inside of the illumination device 100 may be exposed to external air outside the illumination device 100 through the vent holes 124. The size of the vent holes 124 may be determined according to the numbers, shapes, and sizes of the heat dissipation pins 122 formed on the heat sink 12. According to the size of the vent holes 124, an area of an external surface of the housing 10 exposed to the external air may be determined. When the heat sink 12 is coupled to the housing 10, at least a part of the external surface of the housing 10, more specifically, a portion of the upper housing 102 may be exposed to the external air through the vent holes 124 between the heat dissipation pins 122 of the heat sink 12. A portion of a surface of the upper housing 102 or the internal of the illumination device 100 may be exposed to the external air through spaces of the vent holes 124 between the first and second heat dissipation pins 122a and 122b of the heat sink 12, and thus, the efficiency of heat dissipation from inside the illumination device 100 to the outside may be increased.

In this manner, the heat sink 12 of the illumination device 100 according to the current exemplary embodiment may include a plurality of heat dissipation pins 122 extending downward from the body unit 120, that is, towards the housing 10, and spaces between the heat dissipation pins 122 may have a structure exposing the external surface of the housing 10. The heat sink 12 of the illumination device 100 according to the current exemplary embodiment includes a plurality of heat dissipation pins 122, and at least a region between the heat dissipation pins 122 may have the vent holes 124 to expose the external surface of the housing 10 to the external air, and this type of heat sink 12 is referred to as an open type heat sink.

FIG. 3 is a schematic lateral cross-sectional view of the illumination device of FIG. 2.

Referring to FIGS. 1, 2, and 3, heat inside the illumination device 100 may be generated mainly from the light source unit 14 and the PSU 11 of the illumination device 100. Heat generated from the light source unit 14 may be rapidly dissipated to outside the illumination device 100 through the heat sink 12. Heat generated from the PSU 11 may be dissipated to outside the illumination device 100 through the housing 10, and also, may be dissipated to outside the illumination device 100 through the heat sink 12 that is in contact with the housing 10. A heat dissipation area may be increased by forming at least one heat dissipation pins 122 on the heat sink 12, and accordingly, heat dissipation efficiency may be increased. Also, the vent holes 124 may be formed at least on a side or between the heat dissipation pins 122. An upper surface of the housing 10 may be exposed to external air through the vent holes 124 of the heat sink 12, and the heat dissipation efficiency may be increased by increasing an exposure area with respect to the external air of the housing 10. In the illumination device 100 according to the current exemplary embodiment, the PSU 11 and the light source unit 14 may be regarded as heat sources that generate heat inside the illumination device 100, and heat generated from the PSU 11 and the light source unit 14 may be dissipated to outside the illumination device 100 through another heat dissipation path.

In the illumination device 100 according to the current exemplary embodiment, a material for forming the housing 10 is not limited. For example, the material for forming the housing 10 may include various kinds of synthetic resins, a synthetic resin in which a filler is distributed, or a metal. The housing 10 may be formed of a material having a relatively high thermal conductivity since the housing 10 directly contacts the PSU 11 that is a heat generation source. The housing 10 may be formed by injection molding, etc. Also, the heat sink 12 may be formed of a metal or may be formed by including a material having high thermal conductivity, such as a synthetic resin in which filler is distributed. The PSU 11 inserted into the housing 10 is, for example, a printed circuit board (PCB) on which parts are mounted, and may be formed as a “T” shape to correspond to an inner shape of the housing 10.

The light source unit 14 may include a substrate 140 and at least one of light-emitting devices 15 mounted on the substrate 140. The light-emitting devices 15 may be semi-conductor devices that may emit light by receiving external power. The light-emitting devices 15 may be light-emitting diodes (LEDs). The light-emitting devices 15 may emit light having a wide range of wavelengths, and may emit red, green, blue, or white light according to materials included in the light-emitting devices 15. A plurality of light-emitting diode chips may be packaged by a free molding method using a lead frame, a mold frame, a fluorescent body, or transparent filler, and may be mounted on the substrate 140 of the light-emitting devices 15. Also, in the light-emitting devices 15, the plurality of light-emitting diode chips may be mounted on the substrate 140 by using a wire bonding method or a flip-chip bonding method.

The substrate 140 may be, for example, a conductive circuit pattern formed on an insulating base layer, such as, a PCB. For example, the substrate 140 may include a metal PCB, a flexible PCB, a ceramic PCB, or a MC PCB. Also, the substrate 140 may be a metal substrate or a circuit substrate having a metal core to increase the heat dissipation characteristic. The substrate 140 may be formed of a material, a surface of which may reflect light emitted from the light-emitting devices 15. The substrate 140 may be placed on an inner surface 126 of the heat sink 12. The substrate 140 may be fixed on the heat sink 12, and, for example, may be coupled to the heat sink 12 by using screws 142. The number, location, or array type of the light-emitting devices 15 mounted on the substrate 140 may be controlled in various ways. An external power may be supplied to the light-emitting devices 15 through the terminal unit 18 and the PSU 11. If the external power is an alternate current, the alternate current may be converted to a direct current.

A cover unit 16 that covers the light source unit 14 may be formed on the light source unit 14. The cover unit 16 may include at least one of lens elements 168 formed to correspond to each of the light-emitting devices 15 to control an angle of pointing of light generated from the light-emitting devices 15 mounted on the substrate 140. The cover unit 16 may include a coupling unit 162 to be coupled to the heat sink 12. The coupling unit 162 may be formed as, for example, a hook shape to be inserted into insertion regions 128 that are formed on an inner side of the heat sink 12 and is formed downwards from the cover unit 16. The cover unit 16 may function as a lens and may diffusedly reflect and diffusedly transmit light. Also, the cover unit 16 may perform a function of maintaining the shape of the light source unit 14 or protecting the light source unit 14. The cover unit 16 may be formed of a transparent or a semitransparent material having high transparency. For example, the cover unit 16 may be formed of a ceramic material, such as, glass, alumina Al2O3, a polycarbonate (PC) group resin, or a polymethylmethacrylate (PMMA) group resin. Also, in order to increase the thermal conductivity of the cover unit 16, filler may further be additionally included in the glass, the PC group resin, or the PMMA group resin. Examples of filler may be particles of carbon nanotube or graphene, and also, particles of titan oxide, zinc oxide, zirconium oxide, aluminum nitride, or aluminum oxide. The cover unit 16 may be formed by using a molding method, such as, an injection molding, a blow molding, etc.

The illumination device 100 according to the current exemplary embodiment may be a MR16 LED lamp. In the current exemplary embodiment, the heat sink 12 may include at least one of heat dissipation pins 122, and a surface of the housing 10 is exposed to the outside air by forming the vent holes 124 on at least a side of the heat dissipation pins 122 or between the heat dissipation pins 122, and thus, the heat dissipation efficiency may be increased. The weight of the heat sink 12 may be reduced by forming the heat dissipation pins 122 and the vent holes 124. In the illumination device 100 according to the current exemplary embodiment, high heat dissipation efficiency may be maintained without having an additional cooling fan, and the illumination device 100 according to the current exemplary embodiment may satisfy the lamp specification of ASTM.

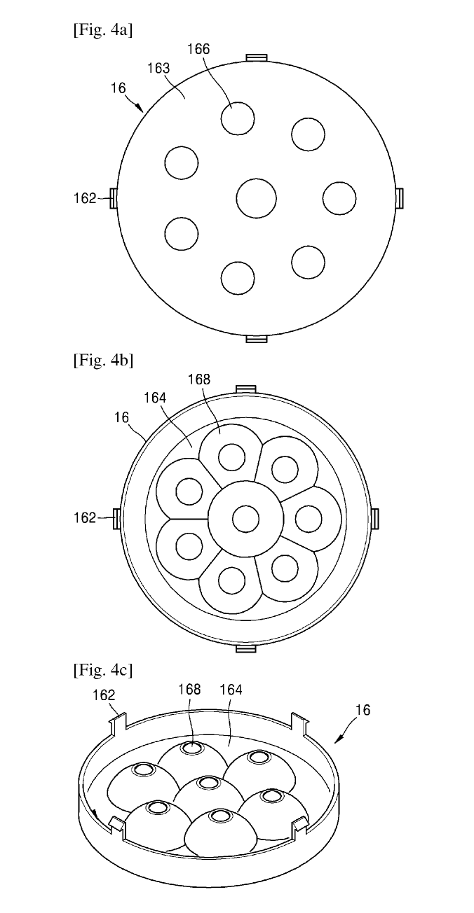

FIG. 4a is a plan view of a cover unit 16 of an illumination device according to an exemplary embodiment.

FIGS. 1 through 3, it is depicted that the cover unit 16 has a flat surface. However, the current exemplary embodiment is not limited thereto, and as depicted in FIG. 4a, at least one of the lens elements 168 may be formed on the cover unit 16 to correspond to the locations of forming the light-emitting devices 15. An upper surface 163 of the cover unit 16 may flat and may include convex protrusion units 166.

FIG. 4b is a bottom view of the cover unit 16 of the illumination device 100 according to an exemplary embodiment. FIG. 4c is a perspective view of a bottom of the cover unit 16 of the illumination device 100.

Referring to FIGS. 4b and 4c, at least one of the lens elements 168 may be formed on the cover unit 16 to correspond to the respective light-emitting devices 15 formed on the light source unit 14. The lens elements 168 may protrude with a curvature from an inner surface 164 of the cover unit 16, for example, may have a hemisphere shape. The lens elements 168 of the cover unit 16 of the illumination device 100 according to the current exemplary embodiment, for example, some of first lens elements and some of second lens elements may be formed to overlap each other. As depicted in FIG. 3, since the lens elements 168 overlap each other, boundary areas between the lens elements 168 may be spaced apart from the inner surface 164 of the cover unit 16. In this manner, since each of the lens elements 168 are formed to partly overlap each other, the lens elements 168 may configure a single lens as a whole, and thus, light emission efficiency may be increased.

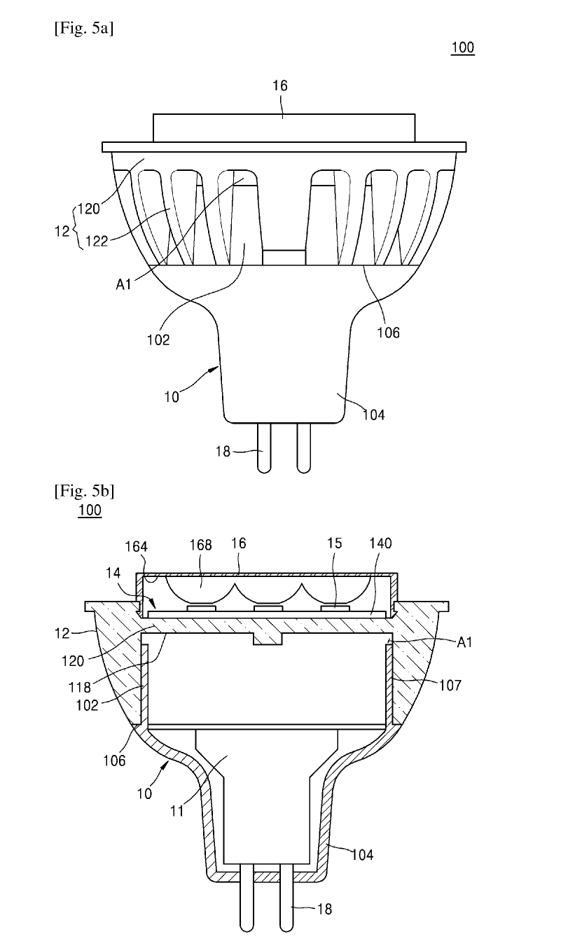

FIG. 5a is a lateral view of the illumination device 100 having a gap A1 between the housing 10 and the heat sink 12, according to an exemplary embodiment. FIG. 5b is a schematic lateral cross-sectional view of the illumination device 100 of FIG. 5a.

Referring to FIGS. 5a and 5b, the illumination device 100 according to the current exemplary embodiment may include a gap A1 which is a space formed by separating the housing 10 from the heat sink 12. The heat sink 12 includes the body unit 120 formed on an upper edge of the housing 10 and the heat dissipation pins 122 formed by extending towards the housing 10 from the body unit 120, and at this point, the gap A1 may be formed by not tightly contacting but separating the upper edge of the housing 10 from the body unit 120 of the heat sink 12. The gap A1 may expose the housing 10 or the inner side of the illumination device 100 to external air. External air may directly enter into the housing 10 through the gap A1, and air inside the housing 10 may be directly exhausted to the outside through the gap A1. Also, external air entered into the illumination device 100 through the gap A1 may effectively discharge heat inside the illumination device 100 to the outside while exhausting to the outside of the illumination device 100. Since the gap A1 is formed between the body unit 120 of the heat sink 12 and the upper edge of the housing 10, air fluidity for reducing the temperature inside the illumination device 100 may be ensured, and as a result, the heat dissipation efficiency of the illumination device 100 may be increased.

The size of the gap A1, that is, a gap between the upper edge of the housing 10 and the body unit 120 of the heat sink 12 may be arbitrary determined, and may be from a few mm to a few tens of mm, for example, in a range from about 2 mm to about 5 mm. heat generated from the PSU 11 and the light source unit 14 of the illumination device 100 may be discharged to the outside of the illumination device 100 through the gap A1. Heat generated from the PSU 11 may be directly dissipated to the outside of the housing 10 through the gap A1, and heat generated from the light source unit 14 is transmitted to the body unit 120 of the heat sink 12 formed below the light source unit 14, and is directly dissipated to the outside of the illumination device 100 through the gap A1.

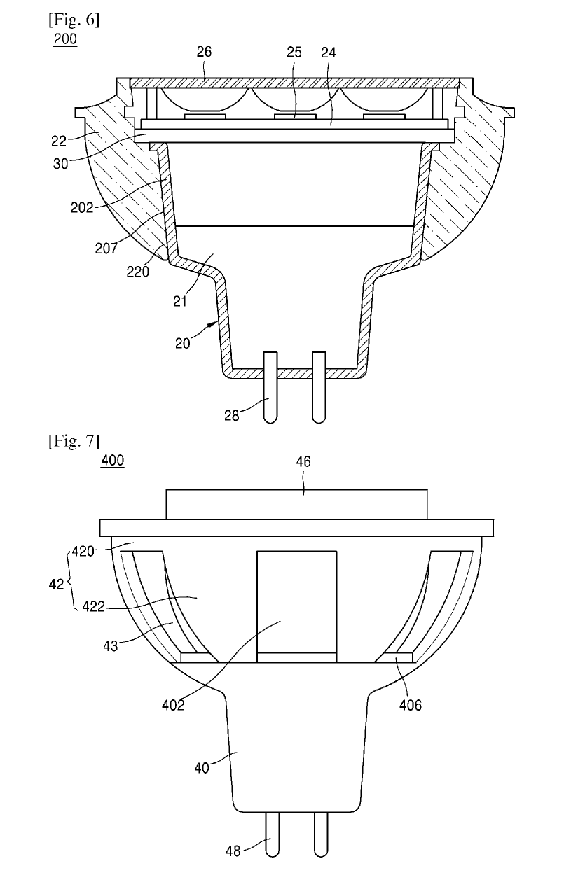

FIG. 6 is a lateral cross-sectional view of an illumination device 200 having a plate 30 between a housing 20 and a heat sink 22, according to another exemplary embodiment.

Referring to FIG. 6, the illumination device 200 according to the current exemplary embodiment may include the plate 30 formed on the housing 20, a light source unit 24 formed on the plate 30, and a cover unit 26 formed on the light source unit 24. A terminal unit 28 may be connected to a lower side of the housing 20, and an upper housing 202 of the housing 20 may be formed in a contact state with the heat sink 22. The heat sink 22 may include at least one of heat dissipation pins 220. The heat dissipation pins 220 of the heat sink 22 may form a contact unit 207 by directly contact with the housing 20. However, the illumination device 200 according to the current exemplary embodiment is not limited thereto, that is, the heat dissipation pins 220 may be spaced apart from the housing 20. Although not shown in FIG. 6, the heat dissipation pins 220 may be spaced apart from each other, and the upper housing 202 may be directly exposed to external air between the spaced heat dissipation pins 220. Accordingly, heat inside the housing 20 may be directly dissipated to the outside. Heat generated from a power supply unit 21 and the light source unit 24 of the illumination device 200 may be respectively dissipated to the outside by the housing 20 and the heat sink 22. Heat generated from the power supply unit 21 may be dissipated to the outside through a lower side and an upper side of the housing 20. In particular, since the upper housing 202 is also exposed to the outside through regions between the heat dissipation pins 220 of the heat sink 22, and thus, heat dissipation efficiency may be increased. Heat generated from the light source unit 24 may be transmitted to the heat sink 22 through the plate 30. In this way, since the plate 30 having a high thermal conductivity is formed between the light source unit 24 and the heat sink 22, heat generated from the light source unit 24 may be effectively dissipated to the outside through the plate 30 and the heat sink 22.

In the case of the illumination device 100 of FIG. 1, when the housing 10 and the heat sink 12 are coupled, a bottom-up method in which the heat sink 12 is downwardly coupled to the housing 10 from above the housing 10 may be used. The coupling method of the illumination device 200 according to the current exemplary embodiment is not limited thereto, that is, in the case of the illumination device 200 of FIG. 6, a top-down method in which the housing 20 is downwardly inserted into the heat sink 22 from above the heat sink 22 may be used.

FIG. 7 is a lateral view of an illumination device 400 having a heat sink 42 formed by a press cutting method.

Referring to FIG. 7, the illumination device 400 according to the current exemplary embodiment may include a heat sink 42 formed on a housing 40. The heat sink 42 may include a body unit 420 that is placed on the housing 40 and a plurality of heat dissipation pins 422 formed by extending downwards from the body unit 420, for example, by extending towards the housing 40 from the body unit 420. The heat dissipation pins 422 may be formed by various methods, for example, by a press cutting method. In order to form the heat sink 42, the heat sink 42 may be molded by forming at least one of vent holes 43 on predetermined regions of a material for forming the heat sink 42 by using a press cutting method. Both laterals of the vent holes 43 may be heat dissipation pins 422. The sizes and shapes of the vent holes 43 and the heat dissipation pins 422 are not specifically limited but may be arbitrary selected. Edges of the heat dissipation pins 422 may extend to a step unit 406 of the housing 40. The heat dissipation pins 422 may contact or may be spaced apart from the upper part of the housing 40, that is, the upper housing 202. A terminal unit 48 for supplying external power to the illumination device 400 may be connected to an edge of the housing 40.

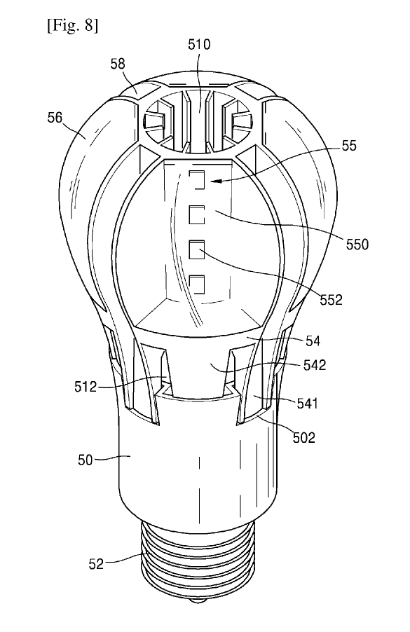

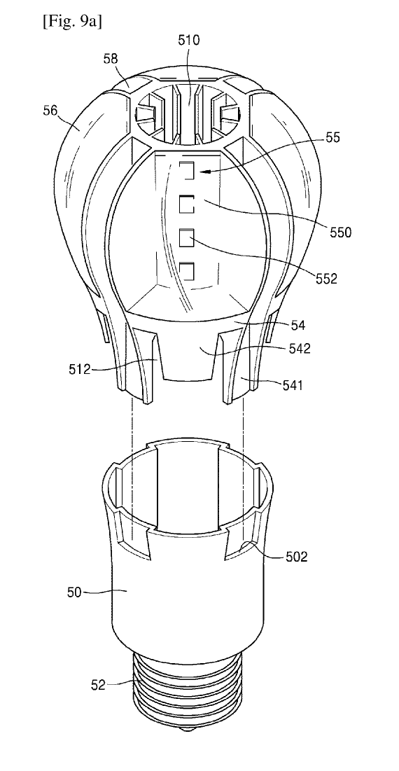

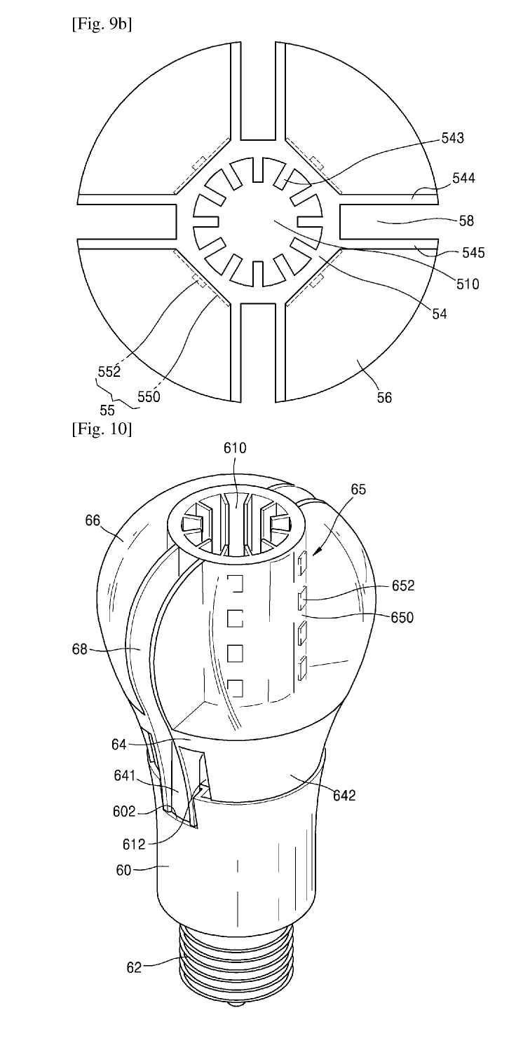

FIG. 8 is a perspective view of an illumination device according to another exemplary embodiment. FIG. 8 shows an omni-bulb lamp that includes a heat sink. FIG. 9a is a perspective view of the illumination device of FIG. 8 having a structure in which a housing and a heat sink are separate from each other. FIG. 9b is a plan view of an upper surface of the illumination device of FIG. 8.

Referring to FIGS. 8, 9a, and 9b, a heat sink 54 may be formed on a housing 50. At least one of heat dissipation pins 541 and 542 extending towards the housing 50, that is, extending downwards may be formed on a lower part of the heat sink 54. The heat sink 54 and the housing 50 may be coupled to each other by coupling the at least one of the heat dissipation pins 541 and 542 to a step unit 502 formed on an edge of the housing 50. A socket unit 52 for supplying external power to the illumination device may be formed on the edge of the housing 50, and a power supply unit may be formed on an inner side of the housing 50. A plurality of light source units 55 may be formed on the heat sink 54, and a cover unit 56 may be formed on the light source units 55.

The locations on which the light source units 55 are formed may be arbitrary selected. In FIG. 8, as an example, the light source units 55 are formed to face various directions on a surface of the heat sink 54. The cover unit 56 may be formed above each of the light source units 55 to correspond to the locations where the light source units 55 are formed. The light source units 55 may include light-emitting devices 552 formed on a substrate 550. Heat generated from the light-emitting devices 552 of the light source units 55 may be transmitted to the heat sink 54 through the substrate 550, and thus may be dissipated to the outside.

A first vent hole 510 may be formed in the heat sink 54 from an upper surface thereof. The first vent hole 510 may be formed vertically downwards from the upper surface of the heat sink 54 by passing through the heat sink 54. Also, as depicted in FIG. 8, second vent holes 512 may be formed between the heat dissipation pins 541 and 542 formed on a lower edge of the heat sink 54 of the illumination device and the upper edge of the housing 50. The first vent hole 510 and the second vent holes 512 may be connected to each other. Since the first vent hole 510 and the second vent holes 512 are connected to each other, external air entered into the illumination device may be exhausted to the outside of the illumination device through the second vent holes 512. Also, external air that enters into the illumination device may be exhausted to the outside through the first vent hole 510.

External air may move in the illumination device through the first and second vent holes, and accordingly, the efficiency of heat dissipation of heat inside the illumination device may be increased. Heat generated from the light source units 55 may be dissipated to the outside of the heat sink 54 by directly transmitting to the heat sink 54. Also, heat generated from the light source units 55 may be transmitted in the heat sink 54, and thus, the temperature of the heat sink 54 may be increased. Heat in the heat sink 54 may be dissipated to the outside by external air that circulates through the first vent hole 510 or the second vent holes 512 and is exhausted through the second vent holes 512 or the first vent hole 510. Heat generated from the power supply unit in the housing 50 may be dissipated to the outside of the illumination device through a surface of the housing 50 or by external air through the first vent hole 510 or the second vent holes 512.

Also, as depicted in FIG. 9b, inner heat dissipation pins 543 that protrude from a surface of the heat sink 54 are formed in the first vent hole 510 to increase a surface area of the heat sink 54, and thus, the heat dissipation efficiency may be increased. Also, at least one of protruded partition walls 544 and 545 may be formed on an external surface of the heat sink 54 to increase the surface area of the heat sink 54. The light source units 55 and the cover unit 56 may be formed on first regions of the heat sink 54 between the partition walls 544 and 545, and second regions between the partition walls 544 and 545 may be exposed to the outside as empty spaces 58. The partition walls 544 and 545 may extend to heat dissipation pins 541 formed on a lower part of the heat sink 54, and thus, surface areas of the heat dissipation pins 541 are increased. Accordingly, the heat dissipation efficiency is increased. The partition walls 544 and 545 may greatly increase the heat dissipation efficiency of the illumination device while increasing the heat dissipation efficiency of the illumination device together with the heat dissipation pins 541. The partition walls 544 and 545 may increase the surface area of the heat sink 54 by protruding from lateral surface of the heat sink 54. Thus, the partition walls 544 and 545 may be referred to as lateral heat dissipation pins, and the heat dissipation pins 541 and 542 formed on the lower edge of the heat sink 54 may be referred to as lower heat dissipation pins.

FIG. 10 is a perspective view of a modified version of the illumination device of FIG. 9a.

Referring to FIG. 10, a heat sink 64 is formed on a housing 60, and an upper edge of the housing 60 may be coupled to a lower edge of the heat sink 64. At least one of heat dissipation pins 641 and 642 protrude towards the housing 60 may be formed on a lower edge of the heat sink 64. The at least one heat dissipation pins 641 and 642 may be coupled to at least one of step units 602 formed on an upper edge of the housing 60. Accordingly, the housing 60 may be coupled to the heat sink 64. A socket unit 62 for supplying power to the illumination device may be formed on a lower edge of the housing 60, and a power supply unit may be formed in the housing 60. A plurality of light source units 65 may be formed on the heat sink 64, and a cover unit 66 may be formed above the light source units 65.

A first vent hole 610 may be downwardly formed in the heat sink 64 by passing through the heat sink 64. Second vent holes 612 may be formed between the heat dissipation pins 641 and 642 formed on a lower edge of the heat sink 64 and the housing 60. External air may move in the heat sink 64 and the housing 60 through the first vent hole 610 and the second vent holes 612. Accordingly, heat in the illumination device may be readily dissipated to the outside, and thus, the heat dissipation efficiency may be increased. Heat may be generated from the light source units 65 or the power supply unit in the illumination device, and heat generated from the light source units 65 may be dissipated to the outside by being directly transmitted to the heat sink 64. Also, heat generated from the light source units 65 may be transmitted to the heat sink 64, and thus, the temperature of the heat sink 64 may be increased. Heat in the heat sink 64 may be dissipated to the outside of the illumination device by external air that moves through the first vent hole 610 and the second vent holes 612. Also, heat generated from the power supply unit in the housing 60 may be dissipated to the outside of the illumination device through a surface of the housing 60 or by external air through the first vent hole 610 or the second vent holes 612.

The light source units 65 may include light-emitting devices 652 formed on a substrate 650. A cover unit 66 may be formed above regions corresponding to the light source units 65 by being supported by the heat sink 64 and partition walls protruded from the heat sink 64. The cover unit 66 may have an oval shape. In the illumination device depicted in FIG. 10, when compared to the illumination device of FIGS. 9A and 9B, the number of heat dissipation pins 641 and 642, the partition walls, and spaces 68 between the partition walls are reduced. In this manner, the shape of the heat sink 64, the number of heat dissipation pins, and the number of partition walls may be optionally controlled.

According to the current exemplary embodiment, an illumination device having a structure by which heat generated from a light source unit or a PSU may efficiently dissipate to the outside of the illumination device is provided. The weight of a heat sink may be reduced by forming at least one of heat dissipation pins and exposing a housing or an inner space of the housing between the heat dissipation pins. Also, an illumination device that satisfies the lamp specification of the American National Standards Institute (ANSI) and a high speed dimmable illumination device are provided.

While one or more exemplary embodiments have been described with reference to the figures, it will be understood by those of ordinary skill in the art that various changes in form and details may be made therein without departing from the spirit and scope as defined by the following claims.

1. An illumination device comprising:
a power supply unit inserted in a housing;
a heat sink coupled to the housing; and
a light source unit formed on the heat sink,
wherein the heat sink comprises:
at least one heat dissipation pin extending towards an outer surface of the housing,
and vent holes formed on a side of the at least one heat dissipation pin.

2. The illumination device of claim 1, wherein the at least one heat dissipation pin comprises first heat dissipation pins and second heat dissipation pins.

3. The illumination device of claim 2, wherein the vent holes are formed between the first heat dissipation pins and the second heat dissipation pins.

4. The illumination device of claim 1, wherein the vent holes expose a surface of the housing to external air outside the illumination device.

5. The illumination device of claim 1, wherein the vent holes expose an inside of the illumination device to external air.

6. The illumination device of claim 1, further comprising a gap formed by separating the housing from the heat sink.

7. The illumination device of claim 6, wherein the gap is formed by separating a body unit of the heat sink from an edge of the housing, and the gap exposes an inside of the housing or the illumination device to external air.

8. The illumination device of claim 1, further comprising a cover unit formed on the light source unit, and the cover unit comprises at least one lens element.

9. The illumination device of claim 8, wherein the light source unit comprises at least one light-emitting device, and
the at least one lens element corresponds to the at least one light-emitting device and the at least one lens element overlap with each other.

10. The illumination device of claim 1, further comprising a plate formed on the housing, and the light source unit is formed on the plate.

11. An illumination device comprising:
a housing;
a power supply unit inserted in the housing;
a heat sink coupled to the housing; and
a light source unit formed on the heat sink,
wherein the heat sink comprises:
at least one heat dissipation pin extending from an outer surface of the housing;
a first vent hole downwardly formed from an upper surface of the heat sink and passing through the heat sink; and
second vent holes formed on a side of the at least one heat dissipation pin.

12. The illumination device of claim 11, further comprising inner heat dissipation pins that are formed in the first vent hole and protrude from an inner surface of the heat sink.

13. The illumination device of claim 11, further comprising at least one partition wall protruding from an outer surface of the heat sink.

14. The illumination device of claim 13, wherein the at least one partition wall protrudes from a side surface of the heat sink and extends towards the at least one heat dissipation pin.

15. The illumination device of claim 11, wherein the first vent hole and the second vent holes are connected to each other.
